(19) United States
(12) Patent Application Publication
(10) Pub. No.: US 2017/0083988 A1
(43) Pub. Date: Mar. 23, 2017

(54) Apparatus & Method for Autonomous Secure Accounting and Access to Payment for a Dispensing Operation

(71) Applicants: Mark Butsch, Tallahassee, FL (US); Jon Hoffman, Tallahassee, FL (US); Stephen Pollock, Tallahassee, FL (US)

(72) Inventors: Mark Butsch, Tallahassee, FL (US); Jon Hoffman, Tallahassee, FL (US); Stephen Pollock, Tallahassee, FL (US)

(21) Appl. No.: 14/861,000

(22) Filed: Sep. 22, 2015

(51) Int. Cl. G06Q 50/06; G05B 19/416; G06Q 20/32; G06Q 20/20; G06Q 20/18

(52) U.S. Cl. CPC G06Q 50/06; G06Q 20/202; G06Q 20/18; G06Q 20/3276; G05B 19/416; G05B 2219/45076

(57) ABSTRACT

A system and method for automating dispensing operations—such as vehicle fueling operations—using a portable electronic device such as a smart phone. The inventive system includes three major components: (1) A mobile application that resides on a portable electronic device; (2) Software that resides on a remote system server; and (3) Software that runs on a pump control module associated with a particular fuel dispenser. The system allows a user to automatically request and pay for fuel using the portable electronic device.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of dispensing control and payment. More specifically, the invention comprises a system allowing a user to automate payment for a dispensing operation with a hand-held communication device such as a smart phone.

2. Description of the Related Art

Solid state microcontroller-based dispensing control and accounting systems have been commercially available since the early 1980s. The known systems have incorporated many methods of accessing and transferring authorization and payment data, including read-only electronic keys, read/write electronic keys, keypad entry, read-only radio frequency (“RF”) identification (“ID”) tags, read/write RF/ID Tags, magnetic stripe cards, bar code readers, biometrics and inductive coil antennae. Although not all of these devices have been incorporated into fuel dispensing accounting and control systems, hardware and software supporting such access features are presently available from many vendors. The present invention does away with these access devices and instead uses a portable electronic device such as a smart phone.

In order to understand the present invention it is helpful for the reader to understand some of the existing components in dispensing systems. This disclosure uses fuel dispensing systems as the primary exemplary application. Existing fuel dispensing systems fall into two broad categories—mechanical dispensers and electronic dispensers. The present invention may be used with either type. FIG. 1 illustrates a prior art electronic dispenser and FIG. 2 illustrates a prior art mechanical dispenser. FIG. 1 represents an installation for a public-use fueling station. FIG. 2 represents an installation that would be more typical for a fleet fueling installation that may not be open to the public. As will be seen, the use of the inventive components is quite similar for either option and no component should be viewed as being limited to any particular option.

Returning now to FIG. 1, vehicle 103 has been pulled alongside fuel island 102. Fuel nozzle 101 is placed in fuel port 105 of vehicle 103. Electronic dispenser 53 is a prior art fuel dispenser familiar to those skilled in the art. It typically accepts payment via credit or debit cards. Once payment is arranged, a user customarily activates the fueling cycle by pressing a button or lifting a lever such as pump handle 151.

Pump control module 142 communicates with electronic dispenser 53 and is able to control the electronic dispenser. FIG. 10 illustrates the internal operation of the exemplary electronic dispenser of FIG. 1. This type of dispenser is configured for digital control through digital interface 62. Pump control module 142 communicates through this digital interface by sending and receiving information. For example, rather than the pump control module directly controlling a relay that applies power to a fuel pump, the pump control module sends a digital message through digital interface 62 and relies on dispenser computer 52 to actually control the relay and other hardware.

The generic electronic dispenser 53 comprises motor controller 56, which controls motor 59 driving pump 58. Pump 58 drives fuel through meter 55, through solenoid valve 63, and to the fuel nozzle 101. Register 60 displays the amount of fuel that passes through meter 55 and turns pulser 57 so that pulser 57's output is also proportional to the fuel passing through meter 55. Upon power application to motor controller 56 and motor 59, indirectly or directly, a reset motor 61 sets register 60 to zero and allows motor 59 or solenoid valve 58 to be activated, thereby allowing dispensing of fuel. Within the mechanics of the reset motor 61 is a pump handle 64, operation of which initiates a fuel scenario upon removal or returning of the fuel nozzle from/to the dispenser (Some electronic dispensers no longer use a handle and just use a push button but the operational principles are the same). Dispenser computer 52 is capable of monitoring pump handle 64's position to determine fueling scenario initiation and completion, controlling motor controller 56, serial communication via intrinsically safe barrier 54 and serial interface 62, control of reset motor 61, and interface with pulser 57.

The reader should bear in mind that many different types of electronic dispensers are on the market. The version shown in FIGS. 1 and 10 is only one example. The exterior configuration of other examples will be different and the interior components will be different.

FIG. 2 illustrates a representative prior art mechanical dispenser 148. As for the prior example, a vehicle 103 has stopped next to fuel island 102. Mechanical dispenser 148 is mounted on this fuel island. Mechanical dispenser 181 is controlled by pump control module 181. Pump control module 181 directly controls the actions of the mechanical dispenser (rather than communicating through a digital interface). FIG. 11 depicts a block diagram for a generic mechanical dispenser 148 and pump control module 181. The mechanical dispenser includes motor 155, a motor controller 149 and solenoid valve 153 regulating the flow to the nozzle. Pump control module 142 is configured to interface with different types and variations of dispensers including, for example: (1) a mechanical dispenser 148 with only motor 155, wherein pump control Module 181 controls motor 155 directly: (2) a mechanical dispenser 148 with both motor 155 and motor controller 149, wherein Pump Control Module 181 controls the motor controller 149; and (3) a mechanical dispenser 148 with solenoid valve 153 located in the fuel line, both with or without motor 155 and/or motor controller 149, wherein pump control module 142 controls solenoid valve 153.

The generic mechanical dispenser 148 shown in FIG. 11 comprises motor controller 149, which controls motor 155 driving pump 154. Pump 154 drives fuel through meter 156, through solenoid valve 153, and on to the fuel nozzle 101. Register 157 displays the amount of fuel that passes through meter 156 and turns pulser 150 so that pulser 150's output is also proportional to the fuel passing through meter 156. Upon power application to motor controller 149 and motor 155, indirectly or directly, a reset motor 152 sets register 157 to zero and allows motor 155 or solenoid valve 153 to be activated, thereby allowing dispensing of fuel. Within the mechanics of the reset motor 152 is a pump handle 151, pump control module 142 is capable of monitoring pump handle 151's position to determine fueling completion.

In prior art use, the mechanical dispenser is generally monitored and controlled by an external fuel management unit 72 (shown in FIG. 2). This external fuel management unit (“FMU”) may be configured to receive fleet fueling cards and the like. In the present invention the FMU will preferably remain active and available, but it is not necessary for the invention's operation.

FIG. 12 shows a pump control module (“PCM”) 142 configured for use with an electronic dispenser. The PCM sends and receives external communications through any suitable means. In the example shown. Ethernet connection 205 provides communication to a local Internet-connected system server. Communications could also be via WiFi or a cellular network.

Various internal components are shown connected to processor 233. Significantly, however, the only control connection between this type of PCM and the dispenser it controls is a data bus—in this case serial input/output 144. Every action that needs to be commanded can be commanded through this digital connection.

FIG. 13 shows a PCM 181 that is configured for use with a mechanical dispenser 148. In this example several control lines must be connected from the PCM to the dispenser. The PCM thereby directly controls dispenser features such as motor controller 149, reset motor 152, and solenoid valve 153.

A fueling operation will be described with respect to FIG. 1. The operator removes fuel nozzle 101 from electronic dispenser 53, moves the fuel dispenser's pump handle 151 to the fueling position, inserts fuel nozzle 101 into fuel port 105 of the vehicle's fuel tank, and dispenses fuel. In many cases, pump handle 151 need not be manually moved to the fuel position since this feature has been designed to be an automatic result of removing nozzle 101 from the dispenser's nozzle storage feature.

The above-described fueling procedure is identical to that normally followed when a fueling site does not include the present invention (except for the lack of a manual payment transaction). This identity is desirable since it reduces or eliminates the need for special training.

### BRIEF SUMMARY OF THE PRESENT INVENTION

The present invention includes a system and method for automating dispensing operations—such as vehicle fueling operations—using a portable electronic device such as a smart phone. The inventive system includes three major components: (1) A mobile application that resides on a portable electronic device; (2) Software that resides on a remote system server; and (3) Software that runs on a pump control module associated with a particular fuel dispenser.

The mobile application on the portable device serves as the user interface. A user registers the portable device, preferably including the creation of a user ID, a password, and automated payment information (such as credit card information). In order to be used in the system a fueling dispenser must be equipped with a pump control module (PCM). A graphic is applied to the fuel dispenser. This graphic includes a readable code. A registered user wishing to use the dispenser points a portable device such as a smart phone at the applied graphic and “captures” a readable code contained in the graphic. This readable code allows the mobile app to learn the identity of the particular dispenser and how to contact the PCM on the dispenser. The mobile app then contacts the PCM.

Once contact is established, the mobile app transfers user and payment information to the PCM. The PCM then transmits this information to the remote system server. The system server requests payment authorization from a banking network server identified in the payment information. Assuming the transaction is authorized, the system server instructs the PCM to allow fueling. Following completion of the fueling the PCM sends information regarding the type and amount of fueling performed to the system server. The system server then automatically processed the payment and returns “receipt” information to the PCM and ultimately to the mobile app.

### BRIEF DESCRIPTION OF THE SEVERAL VIEWS OF THE DRAWINGS

FIG. 1 is a perspective view, showing a fueling station with an electronic dispenser.

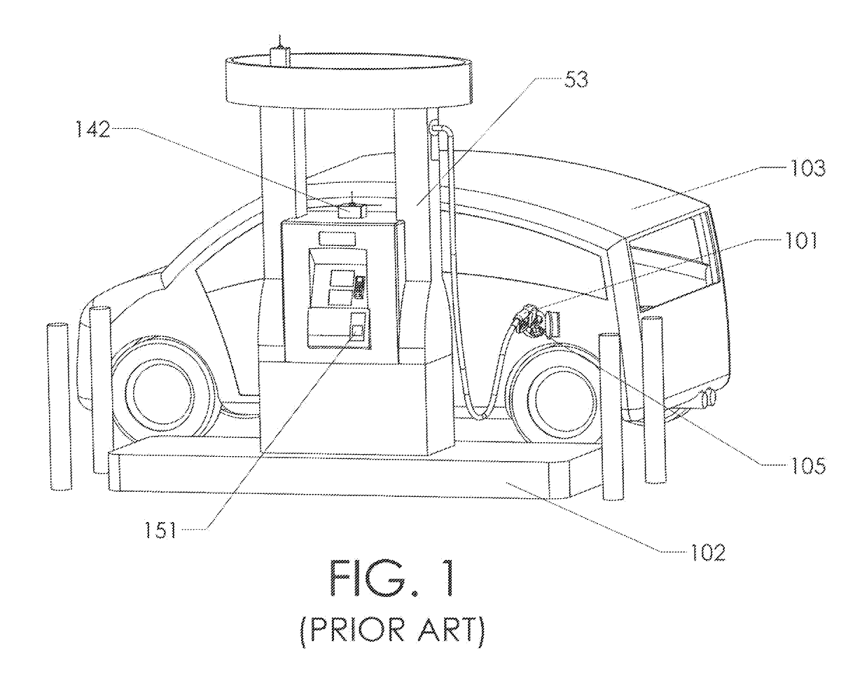

FIG. 2 is a perspective view, showing another type of fueling station incorporating a mechanical dispenser.

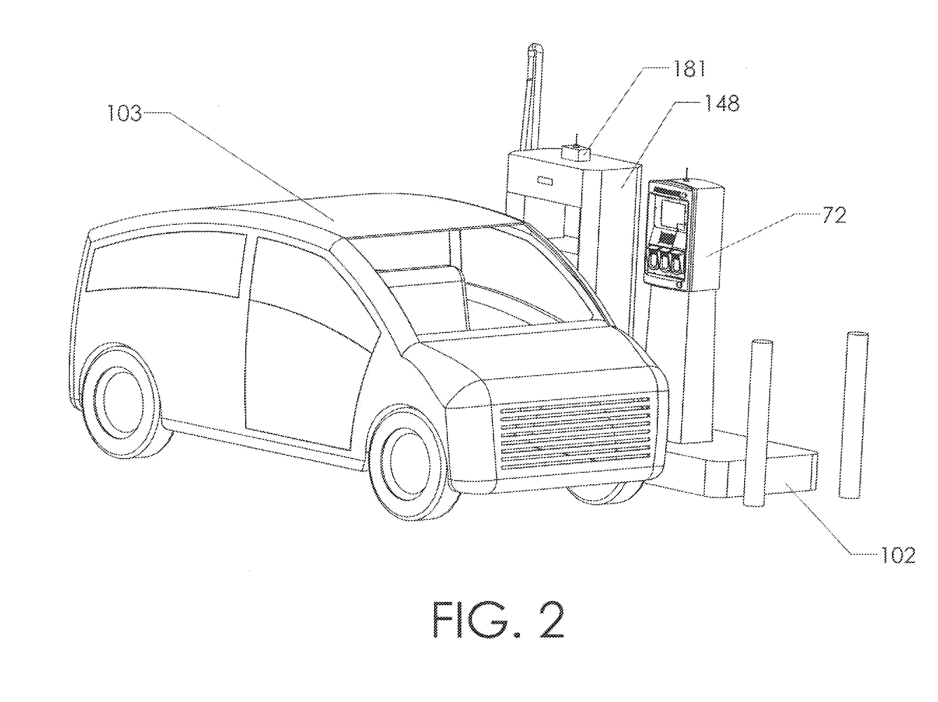

FIG. 3 is a detailed perspective view, showing a graphic applied to a fueling station for use with the present invention.

FIG. 4 is an elevation view showing two types of readable codes that may be used with the present invention.

FIG. 5 is a perspective view, showing one type of hand-held electronic device.

FIG. 6 is a perspective view, showing the device of FIG. 5 from another vantage point.

FIG. 7 is a detailed perspective view, showing the use of a hand-held device to read a readable code.

FIG. 8 is an elevation view, showing a graphical user interface that may be employed with the present invention.

FIG. 9 is an elevation view, showing additional features of the graphical user interface shown in FIG. 8.

FIG. 10 is a schematic view, showing some internal components of an exemplary electronic fuel dispenser.

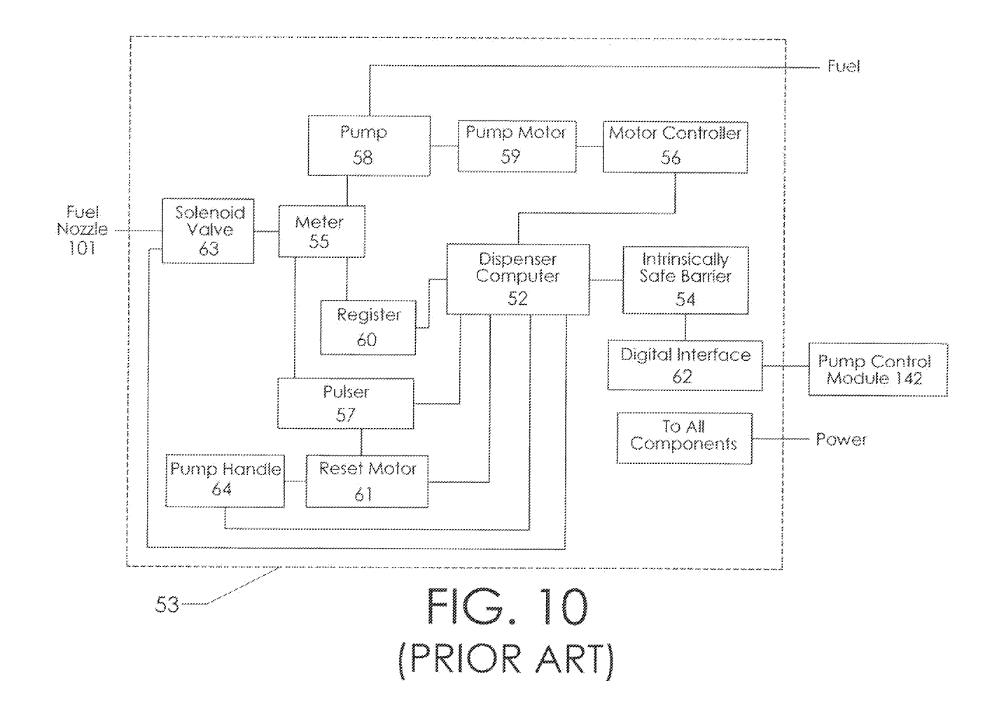

FIG. 11 is a schematic view, showing some internal components of an exemplary mechanical fuel dispenser.

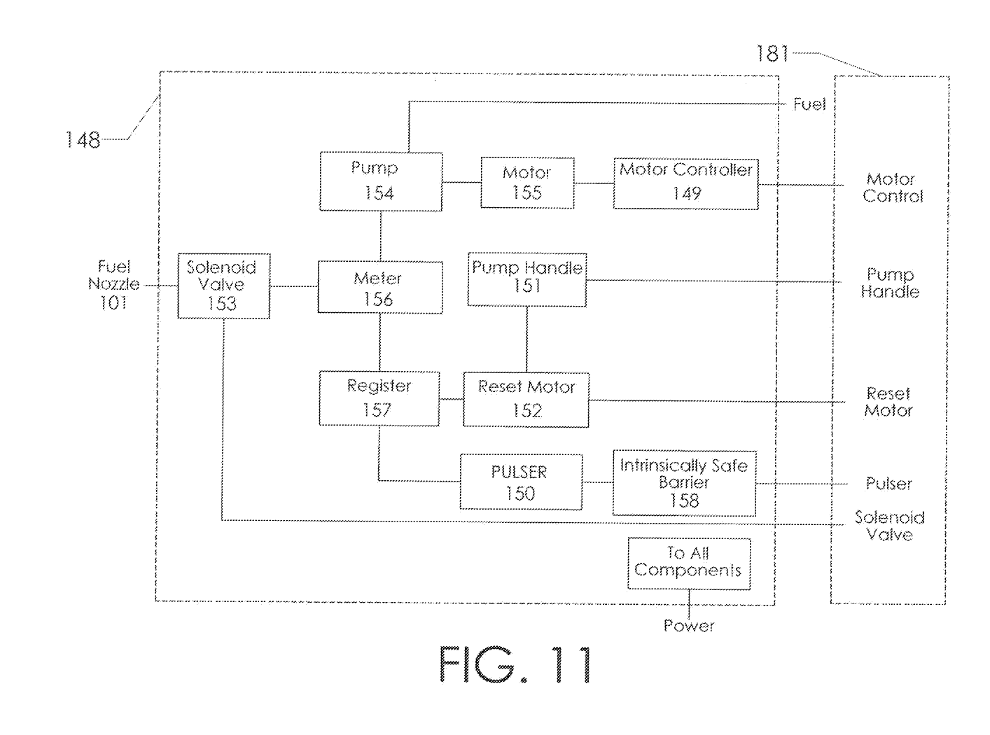

FIG. 12 is a schematic view, showing some of the internal components of a pump control module configured for use with an electronic dispenser.

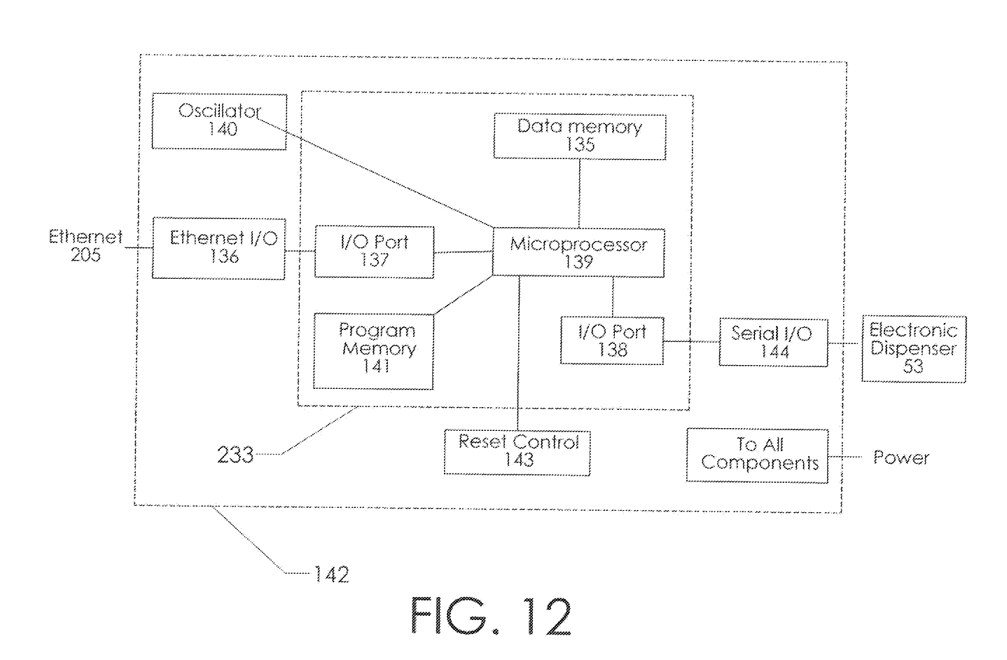

FIG. 13 is a schematic view, showing some of the internal components of a pump control module configured for use with a mechanical dispenser.

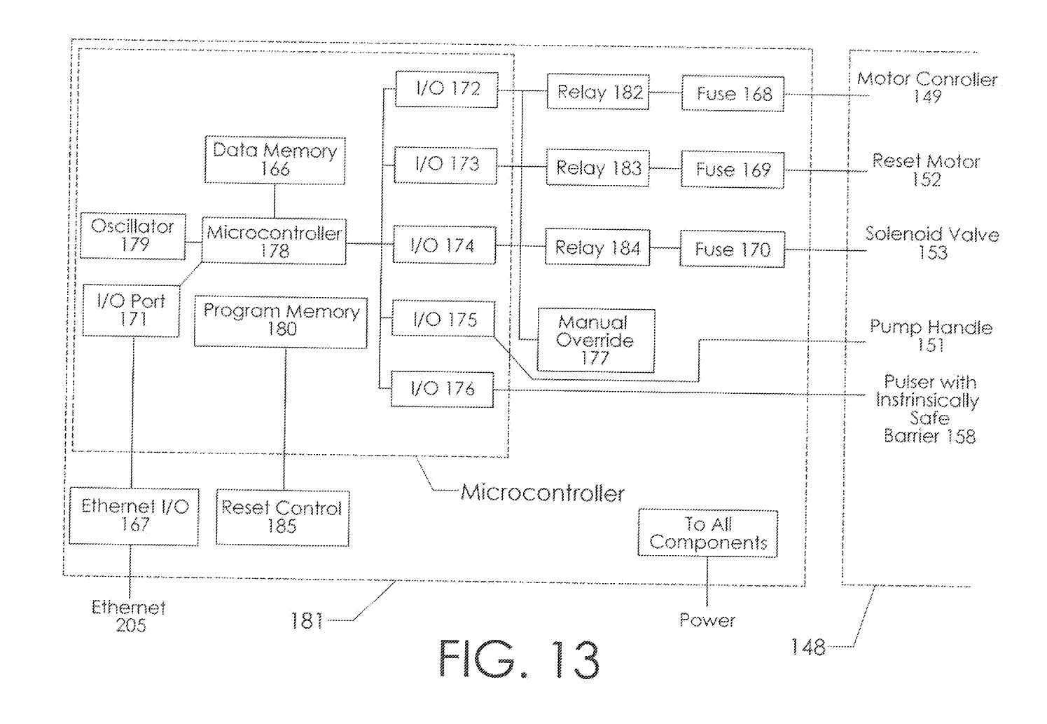

FIG. 14 is a schematic view, showing the communication links between the various components used in the present invention.

FIG. 15 is a flow diagram, showing the flow of information between the components of the present invention.

### REFERENCE NUMERALS IN THE DRAWINGS

20 user interface housing
22 video display
24 electronic payment system
26 applied graphic
28 visual cue
30 readable code
32 bar code
34 quick response code
36 hand-held device
38 display/touch screen
39 message
40 camera
41 capture button
42 image
44 icons
46 paymaster icon
48 dialog box
50 input keys
51 initiate button
52 dispenser computer
53 electronic fuel dispenser
54 alignment grid
56 message
54 intrinsically safe barrier
55 meter
56 motor controller
57 pulser
58 pump
59 pump motor
60 register
61 reset motor
62 serial interface
63 solenoid valve
64 pump handle
72 Fuel Management Unit
101 fuel nozzle
102 fuel island
103 vehicle
105 fuel port
135 data memory
136 Ethernet I/O
137 I/O port
138 I/O port
139 microprocessor
140 oscillator
141 program memory
142 Pump Control Module
143 reset control
144 serial port
148 mechanical dispenser
149 motor controller
150 pulser
151 pump handle
152 motor reset
153 solenoid valve
154 pump
155 motor
156 meter
157 register
158 intrinsically safe barrier
166 data memory
167 Ethernet I/C
168 fuse
169 fuse
170 fuse
171 I/O port
172 I/O
173 I/O
174 I/O
175 I/O
176 I/O
177 manual override
178 microprocessor
179 oscillator
180 program memory
181 pump control module
182 relay
183 relay
184 relay
185 reset control
205 Ethernet
233 processor
240 remote system server
242 cell provider
244 banking network server

### DETAILED DESCRIPTION

The present invention provides a dispensing system in which all operator input to the disbursement process is reduced to a simple communication set via a hand-held electronic device such as a smart phone. The communication set might include one or more of the following:

1. Asking to start a mobile application on the smart phone;

2. Entering a login, which could be remembered by the smart phone if desired:

3. Entering a password; and

4. Entering a unique fuel dispenser identification, which could be automatically obtained by the smart phone.

In the examples that follow a smart phone is used as the hand-held electronic device. The reader should bear in mind that other devices could be used, including tablet devices and smart watches. The invention is not limited to any particular brand or class of device.

All the actions listed within the communication set could be accomplished using a verbal interface with the smart phone or a manual interface using the smart phone's touch screen or keys. Other information can be “captured” using the smart phone's camera—as will be described subsequently. One of the advantageous concepts of the present invention is that very little user input is required to purchase fuel from a dispenser.

The transaction authorization, accounting, dispenser control and payment preferably occur autonomously without further input from the user. A transaction record could be sent to the user's smart phone, and the banking network's billing records and paperwork could also be sent to the user.

The inventive system includes three major components: (1) A mobile application that resides on the smart phone; (2) Software that resides on a remote system server; and (3) Software that runs on a pump control module associated with a particular fuel dispenser.

The mobile application on the smart phone serves as the user interface. This component allows the user to input the needed access and logon information, typically including a user ID and password, and a unique fuel pump identification and possibly a hose identification (for a pump with multiple hoses). The interface also includes the ability to provide information back to the user. The information may include instructions for use and also relevant data (such as reports and receipts). The interface may also give the user the ability to automatically or manually send a receipt to an email address.

The user may be required to register the mobile application by creating a user ID (logon) and password. The user may also be required to provide personal identifying information. The website is hosted by a software program that resides on a secure encrypted system server. Once the logon, password, and personal identification data have been established on the system server, payment information may be entered as well and linked to the specific user. Payment information is typically a credit card number but may include other payment methods such as directly linking a checking account. The payment information is preferably encrypted and kept only on the mobile app on the smart phone. It is preferable to store no payment information on either the system server or the pump control module. Using this approach helps guard against hostile “hacks” since even a successful hack will not compromise any payment information.

During both the transaction authorization and the transaction completion processes encrypted payment information may be temporarily stored on the system server, as this will likely be needed for processing. Upon completion of a transaction, however, the payment information is preferably deleted from both the system server and the pump control module.

The software program residing on the remote system server preferably provides the following functions:

1. Providing a website interface for customer registration;

2. Providing secure storage for encrypted data, even if the storage is only for a very short period;

3. Providing transaction initiation services;

4. Decrypting encrypted data sent by a portable electronic device (smart phone) through a pump control module;

5. Initiating communications with the appropriate pump control module;

6. Compiling and securely storing encrypted transaction data including things such as a user ID, fuel dispenser ID, time and date of transaction, and records of the fuel dispensed;

7. Communicating the encrypted transaction data to a banking network for financial processing; and

8. Supporting and providing reporting capabilities to both the system owner and the user.

In the preferred embodiments of the present invention each pump control module includes the following features:

1. Control of one or more fuel dispensers;

2. Transmitting, receiving, and responding to communications from the software program residing on the remote system server;

3. Acting in accordance with instructions received from the remote system server;

4. Recording and storing of fuel dispensing transactions;

5. Communicating the completed fuel dispensing transactions to the remote system server; and

6. Communicating with the user's portable electronic device (smart phone)

In the preferred embodiment of the disclosed invention the pump control module (PCM) resides on or near a fuel dispenser. The PCM may even be incorporated within the housing for the fuel dispenser. As mentioned in the “background” section of this disclosure, there are two general types of fuel dispensers—electronic and mechanical.

When the PCM is configured to control an electronic dispenser the PCM's microcontroller communicates directly with the electronic dispenser's microcontroller (via a digital communication link). This allows the PCM to control the dispensing process (including the amount of fuel dispensed) and monitor the transaction progress.

When the PCM is configured to control a mechanical dispenser the PCM's microcontroller controls the mechanical dispenser via direct control of the mechanical dispenser's relay(s) and fuel valves and via direct monitoring of the mechanical dispenser's flow meter (generally a pulse-generating sensor).

During the installation process a technician will physically mount and electrically connect the PCM to the dispenser it controls (though in some embodiments the PCM may actually be built into the dispenser). After installation of the PCM a technician will install a readable code (such as a bar code) on a suitable surface of the dispenser. The readable code will contain information uniquely identifying the dispenser (and possible a particular hose in the case of multi-hose dispensers). The technician will then initialize the PCM. Initialization will include directing the PCM to initiate communication with the software program residing on the remote system server. The PCM will then pass dispenser identification information to the remote system server, including a unique code (such as a number) associated with the readable code and the physical hose identification. The information preferably also includes the particular PCM's unique IP address.

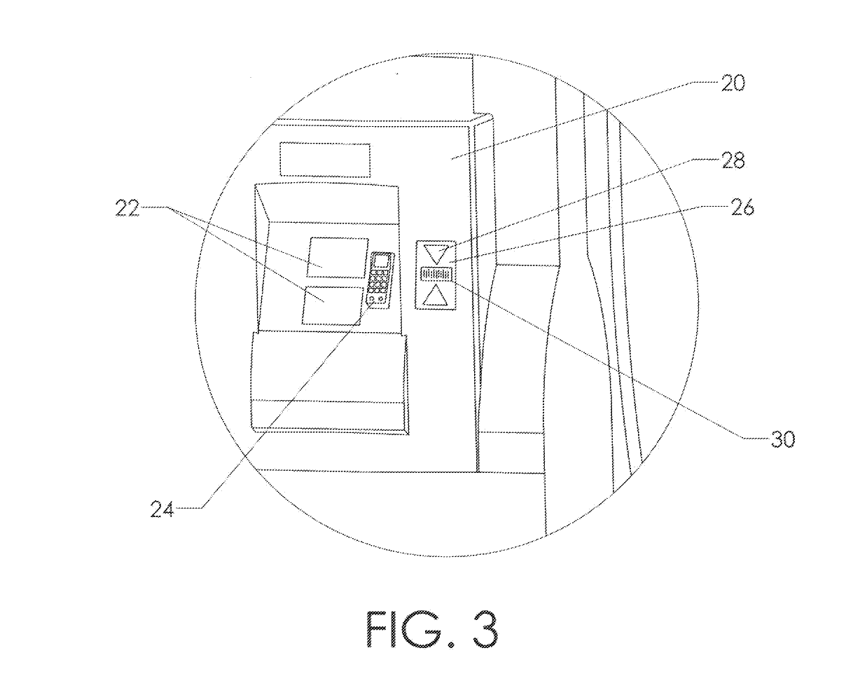

Before turning to additional details, the reader may benefit from an explanation of how the inventive system operates from the perspective of a user. FIG. 3 shows a portion of an electronic fuel dispenser. User interface housing 20 includes video displays 22 and electronic payment system 24. As will be known to those familiar with the art, the video displays prompt the user to take an action (typically inserting a credit card into electronic payment system 24). In the present invention, all the prior art payment mechanisms may be left in place. Thus, a non-registered fuel purchaser or a registered user who wishes forego use of the present invention and instead swipe a prior art credit card may still do so. However, the functionality of the present invention is also made available.

Applied graphic 26 is placed on the dispenser of FIG. 3, preferably in a location that will catch the user's attention. One or more visual cues 28 may be provided. These may include a stylized graphic that identifies the inventive system to the knowledgeable user. Somewhere in the applied graphic is a readable code 30. The readable code is a machine-readable graphic that a smart phone or other device can read and interpret.

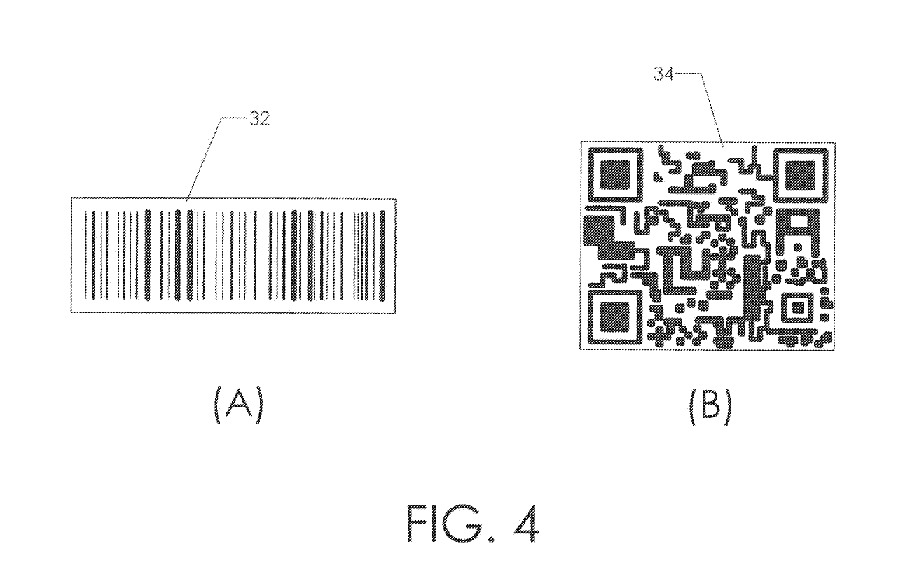

FIG. 4 illustrates two well-known readable codes. FIG. 4(A) shows a linear bar code 32. FIG. 4(B) shows a two-dimensional quick response (“QR”) code 34. Either of these code types can be read using a smart phone.

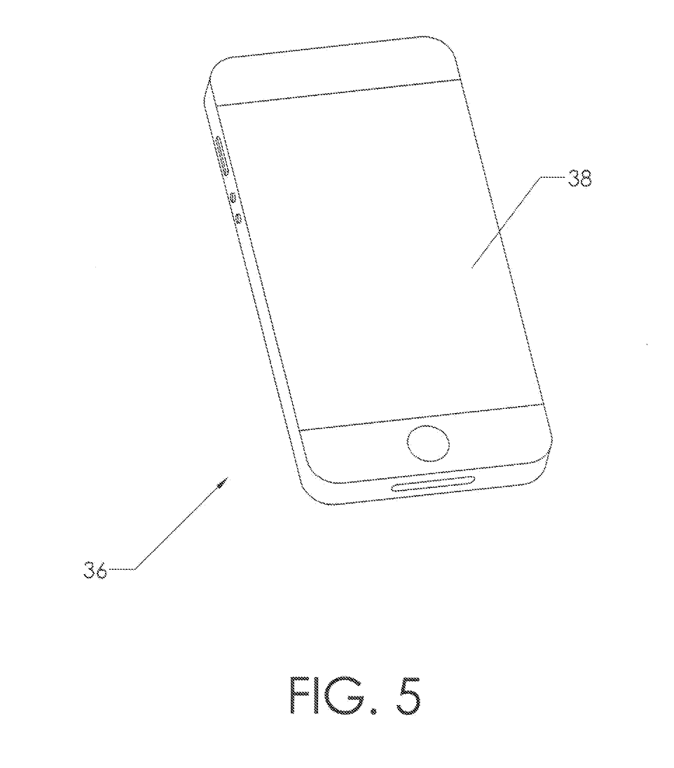

FIG. 5 shows a typical hand-held electronic device 36—in this case a smart phone. This phone has a large display/touch screen 38. As those skilled in the art will know, the screen 38 both displays information graphically and receives user inputs via the user touching the screen at a point or points. Thus, the user interface may allow the display of a virtual “button” and the user can “press” the button by touching the portion of the screen where the button is displayed.

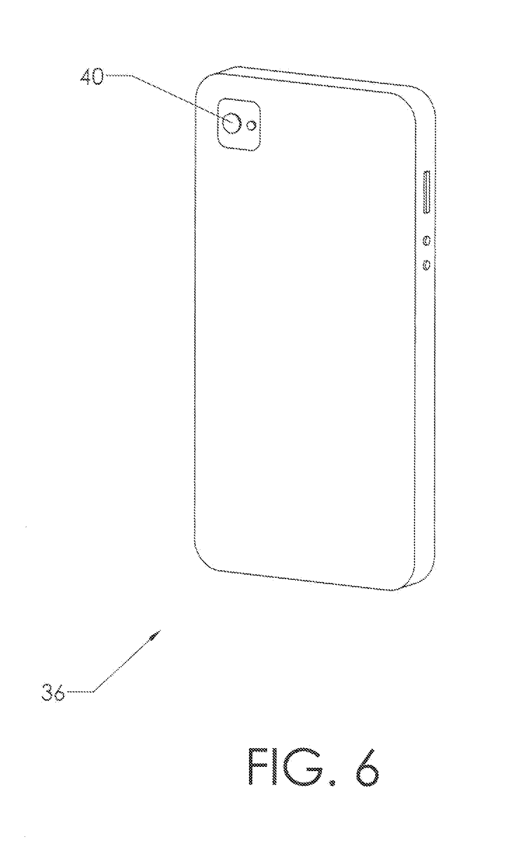

FIG. 6 shows the opposite side of hand-held device 36. Camera lens 40 is provided on the side that typically faces away from the user. A smart phone user is able to point camera lens 40 toward an object and see an image of that object on display/touch screen 38.

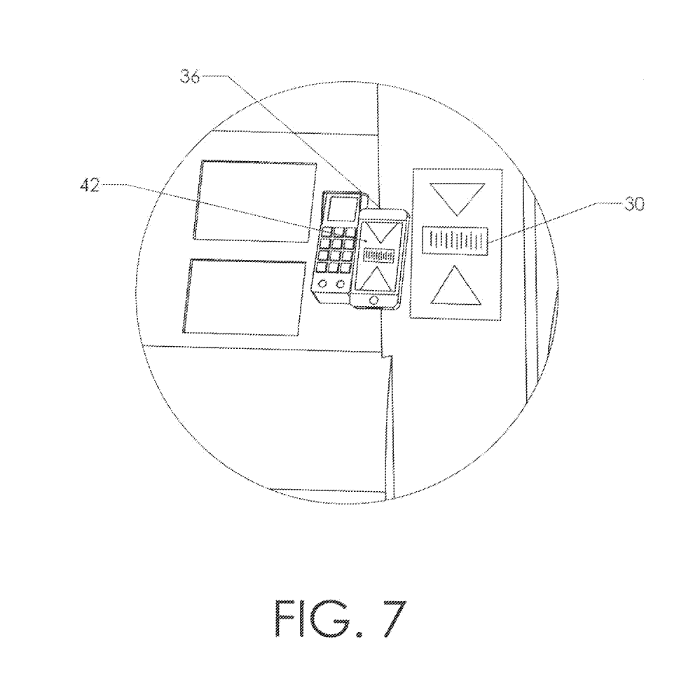

FIG. 7 shows how a smart phone can be used in the present invention. In this example the owner of device 36 has downloaded the application software mentioned previously and that “app” software is installed and running on the device. Further, the owner has registered the device with the remote system server including establishing a user ID, a password, and a method of automated payment. The user points device 36 at readable code 30 so that the readable code is seen by the camera and displayed as image 42 on the display/touch screen. The smart phone then “captures” the bar code image automatically or in response to a user prompt.

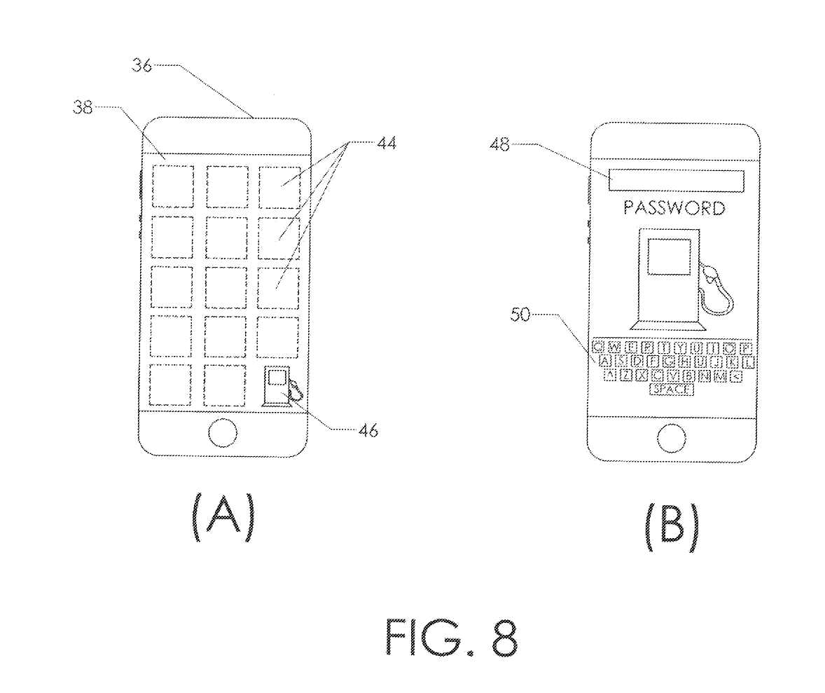

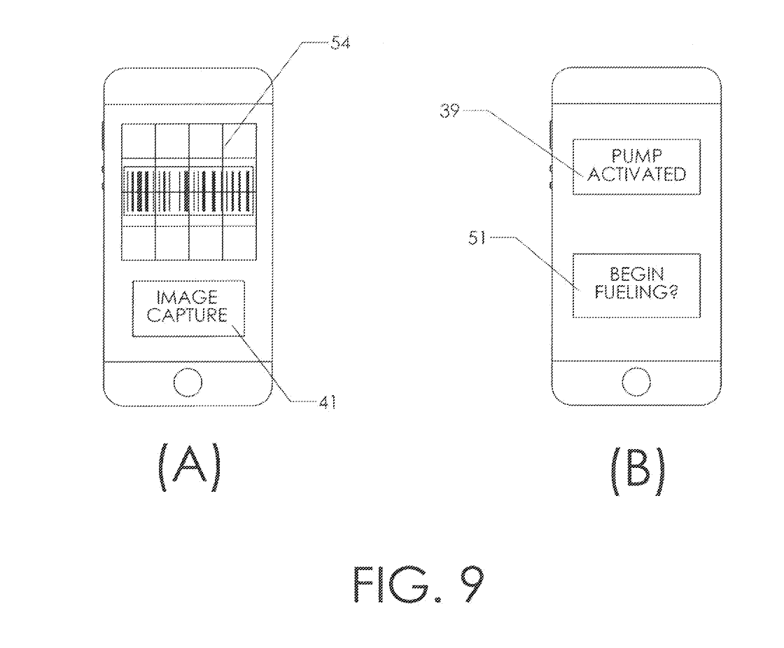

A graphical user interface is provided on the smart phone. This may assume an endless variety of forms. FIGS. 8 and 9 show one form the interface may take. FIG. 8(A) shows a representative “home page” where icons 44 for numerous applications loaded on the smart phone are displayed. Paymaster icon 46 is used to launch the inventive system. If the user selects paymaster icon 46 then the display changes to that shown in FIG. 4(B).

The user interface displays dialog box 48 prompting the entrance of the user's password. Input keys 50 are also displayed. The user presses the various input keys to type in the required password. Once the correct password is entered, the user interface moves on to that depicted in FIG. 9(A). An image from the smart phone's camera is displayed. An alignment grid 54 may be superimposed on the image to aid the user in ensuring that the camera lens is properly aligned with the readable code being “seen” by the smart phone's camera. An image of the bar code may then be captured automatically. Alternatively, the user may be prompted to hit capture button 41 to cause the bar code image to be captured.

Once the bar code image is successfully captured, the application software decodes the information stored in the bar code. This information allows the smart phone to create a communication link with the pump control module on the fuel dispenser. In the preferred embodiment, the link is a limited-range radio frequency link, such as Bluetooth. This R/F link creates a connection from the smart phone to the pump control module (PCM) on the fuel dispenser itself. The PCM then receives information sent by the smart phone and adds additional information before sending the combined information to the remote system server (via a cellular connection, or some other means).

The term “limited-range radio frequency link” means preferably one with a range that is less than or equal to 100 meters. Even more preferably the range is less than or equal to 10 meters. As those skilled in the art will know, most Class 2 Bluetooth devices are limited to 10 meters of range.

In the preferred embodiments payment information is not stored on the remote system server or the PCM. It is only stored on the smart phone, in encrypted form. The remote system server stores only the information needed to determine who is a registered user. Once the Bluetooth link is created between the smart phone and the PCM, the smart phone transmits the payment information to the PCM and the PCM transmits it up to the remote system server. The remote system server thereby receives (1) the identity of the particular fuel dispenser, (2) the identity of the particular registered user attempting to use the fuel dispenser, and (3) the encrypted payment information for that user.

The remote system server decrypts the payment information (such as credit card information) and contacts the appropriate banking network. Assuming that the payment request is verified and ultimately authorized by a separate banking network (more descriptions of this process will be provided subsequently) the remote system server transmits an activation message back to the PCM controlling the selected fuel dispenser. The PCM then sends a response message back to the smart phone. This entire process should take no longer than a few seconds.

The message sent by the PCM back to the smart phone causes the user interface to change to that shown in FIG. 9(B). Message 39 informs the user that the selected fuel dispenser has been successfully activated. Initiate button 51 may also be provided. It allows the user to trigger the dispensing process. Alternatively, the user may simply be told that the dispenser is active and instructed to place the fuel nozzle in the vehicle's fueling port and squeeze the nozzle handle.

The entire process may be completed in much less time than it takes to read this description. An experienced user will simply select the paymaster icon, enter the password, perform an image-capture on the graphic, and begin fueling. No credit card is needed.

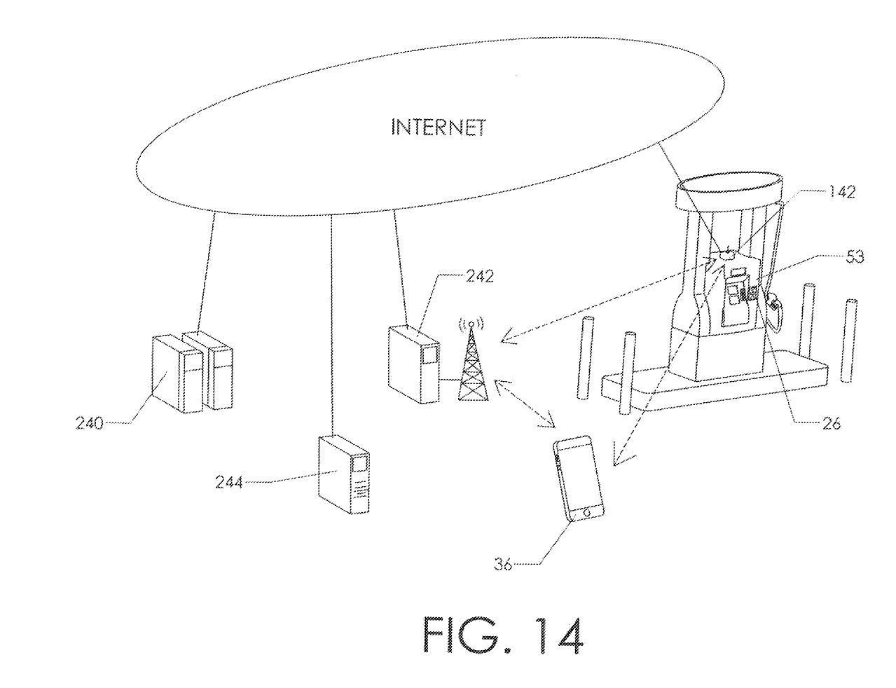

FIG. 14 provides an overall view of the components used in this embodiment and the communication links that may be used between the components. Many of the desired communications are preferably carried out over the Internet so that no dedicated communication links are needed. The mobile application providing the user interface is of course loaded on hand-held device 36 (a smart phone in this example) The controlling software runs on one or more remote system servers 240. A memory associated with the remote system server stores all the information regarding registered users and enrolled fuel dispensers, preferably in encrypted form. Communications to and from the device 36 may be provided via cell provider 242 or a local Bluetooth connection (though they could also be via WiFi or some other means). For instance, the captured image of applied graphic 26 would preferably be converted into a simple identifying sequence of characters within device 36. This sequence of characters would allow the mobile app to contact the pump control module (PCM) 142 on the dispenser—such as by using a Bluetooth link. PCM 142 would then transmit this information (as well as possibly additional information) via a cellular link to cell provider 242. The cell provider would then upload the information as data packets to the Internet (including routing information of course). The Internet would then be used to transmit the data packets to remote system server 240.

Software on remote system server 240 then determines that a registered user is attempting to activate a specific pump (and possibly a specific hose). The remote system server sends messages via the Internet to the cell provider and the cell provider then transmits the message back to PCM 142 on the selected electronic dispenser 53. The system server sends the message data packet along with routing information directing the packets to the IP address for the identified PCM 142. Remote system server 240 is also able to communicate with other servers through the Internet. An example is remote system server 240 communicating with a particular banking network server 244 once it receives payment information from a particular registered user.

The actual communication links used by the various devices to reach the Internet are not particularly important. For example, the PCM might be part of a local wireless network (such as a “WiFi” network operating under the IEEE 802.11 standard) and the communication to the Internet might be via a router instead of a cellular provider. Alternatively, the PCM might have its own internal hard-wired connection.

Likewise, hand-held device 36 might employ cellular communications to transmit the information retrieved from the graphic image capture up to the Internet and it might then be routed to the system server, back to the Internet, and from thence back to the particular PCM. Some descriptions of particular embodiments may be helpful. In the context of currently available smart phones, the user would likely begin by downloading the application software (“app”). The app must then be enrolled (registered) to use the inventive system. For example, the user would typically create or provide:

1. A user ID;

2. A password;

3. The user's full name and address;

4. The user's email address; and

5. Payment information such as a credit card or bank account routing number (though this will only be retained on the smart phone itself).

The user ID and password information are stored as an encrypted file by the mobile app on the smart phone. A unique ID is sent back by remote system server 240 to identify the user and link transactions to the user. Once the registration process is complete the mobile app displays a notification of completion and advises the user that fueling is available. The mobile app can even provide information regarding the location of fuel dispensers that are able to carry out the inventive process.

In the preferred embodiments of the invention the smart phone communicates directly with the pump control module using a limited range wireless connection. In the context of currently-available standards, the preferred communication protocol is Bluetooth (originally standardized by the IEEE as IEEE 802.15.1 but now managed by the Bluetooth Special Interest Group). Bluetooth is a wireless communication standard allowing two devices to exchange data over short distances using UHF radio waves in the band from 2.4 to 2.485 GHz. Smart phones now typically include a Bluetooth interface. Thus, it is a good choice for facilitating direct phone-to-PCM communications.

Bluetooth devices are often operated in the “discoverable mode” where a query from an external device will elicit a response with the device name, device class, etc. In the inventive system the PCM preferably does not operate in this mode. Rather, the mobile app would need to determine the PCM's Bluetooth link information by scanning the readable code. The mobile app would then extract the required Bluetooth linking information from the scanned code. The smart phone would then transmit this to the PCM and the PCM would thereby “know” that the desired link is authorized. In this embodiment the readable code affixed to the fuel dispenser not only stores identifying information about the pump but also the Bluetooth address of the PCM. The smart phone can then use its own Bluetooth interface to begin communicating directly with the PCM.

The inventive system is by no means limited to the Bluetooth communication protocol. However, an important feature of the inventive system is that the readable code affixed to the dispenser be a step in the process of establishing communications between the hand-held device and the pump control module. A registered user must have an app that is able to “decode” the readable code and use the information stored in the readable code to establish communications with the dispenser. This approach greatly enhances the overall system security.

Once communication is established between the smart phone and the PCM, the smart phone sends its locally-stored user and payment information to the PCM. This data is encrypted (such as AES 256 bit encrypted). The PCM acts as a pass-through device. It adds the pump information to that received from the smart phone and sends the information via the cellular provider (or other means) up to the Internet where it is transmitted to remote system server 240. Preferably the PCM does not itself have the ability to decrypt the data received from the smart phone.

Remote system server 240 decrypts the information sent by the PCM and processes it to determine whether the proposed transaction should be approved or denied. Once it determines that it is dealing with an enrolled user it transmits an authorization request to a particular banking network server 244 that is listed by the enrolled user as the mean of payment. The banking network server receives this as a conventional transaction and—if appropriate—approves the transaction. Remote system server 240 sends the approval or denial back to the PCM and the PCM forwards this information to the smart phone via the Bluetooth connection. The mobile app then displays the status and if approval has been received allows fueling.

The user then begins fueling the vehicle. The fueling cycle would be considered completed by either the returning of the pump handle or the termination of flow for a defined interval. Once the fueling is complete the PCM sends the information about the transaction (including fuel grade, fuel quantity, and price, for example) back to remote system server 240. The remote system server then performs the financial transaction to pay for the fuel (such as a credit card transaction). The remote system server next sends “receipt” information back to the PCM and the PCM then completes the transaction by sending the receipt information to the mobile app. The mobile app then displays the receipt information and may also store it for the user's future reference.

In order to make a particular fuel dispenser available to the inventive system, a PCM must be installed. The PCM is required to be mechanically mounted on or near the dispenser it will control. The PCM also needs to be connected to electrical power and to the dispenser itself. Further, the PCM should preferably be able to communicate with the Internet and should preferably have its own IP address. The PCM may be initialized using a Bluetooth address or via Internet-based communications.

Remote system server 240 preferably serves a large number of fuel dispenser owners as well. Each of these owners will also enroll in the system in order to receive processed payments. When a user purchases fuel at a particular dispenser, the remote system server knows where to route that payment.

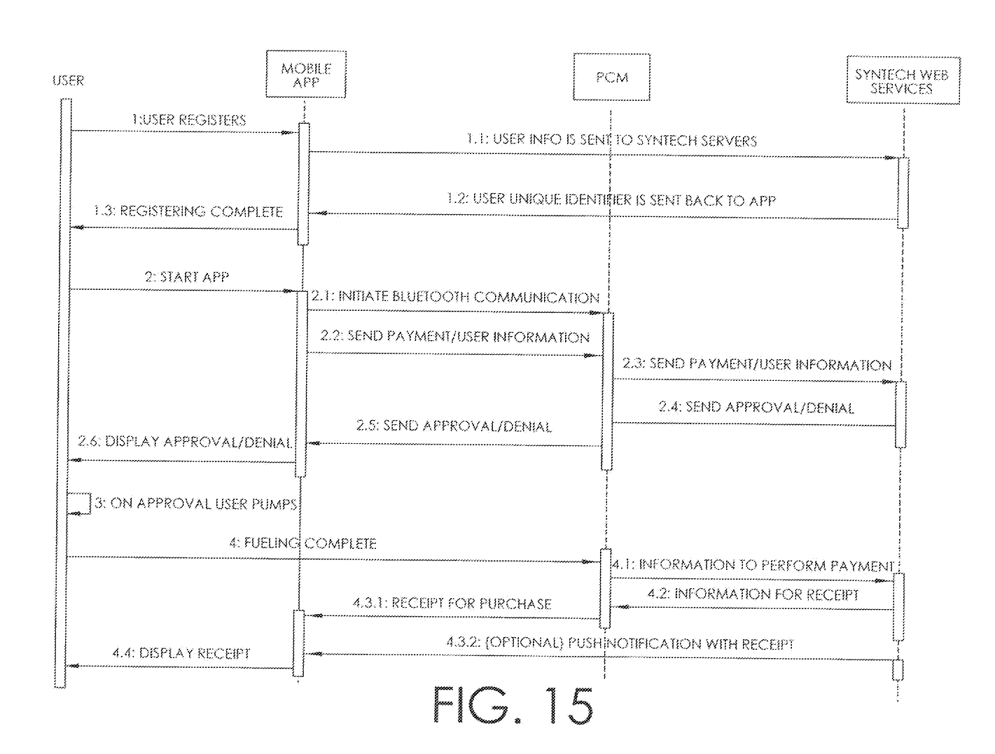

FIG. 15 graphically depicts the flow of information in the inventive system between the mobile app running on a smart phone 36, the pump control module (PCM) 142, and the remote system server 240. In the beginning a new user registers (enrolls) and loads the mobile app on smart phone 36. The mobile app then sends user information directly to the system server over the Internet (using a cell link or WiFi, typically). System server 240 creates a unique user identifier and sends it back to the mobile app. At this point registration is complete and the mobile app displays a suitable message to the user. This portion of the process is typical for a user loading a new app on a smart phone.

The loading of the mobile app and registration of a new user may be done at any time (provided that a cellular or WiFi connection is available). The user does not need to be near an enrolled fuel dispenser. Once registration is complete, the system is ready for use in purchasing fuel.

When the user finds an enrolled dispenser he or she launches the mobile app and performs an image capture on a readable code (see FIG. 7). The smart phone then initiates a Bluetooth communication with the pump control module (PCM). Once the Bluetooth link is established the smart phone sends the payment and user information to the PCM. The PCM then sends the payment and user information up to the system server 240.

The system server 240 receives and processes the information. Once determining that the user is registered the system server requests authorization from the banking network server identified in the payment information (The communication to the banking network server is not shown in FIG. 15). Once an approval or denial comes back the system server sends this information hack to the PCM 142. The PCM then sends this information to the smart phone and the smart phone displays it to the user.

Assuming that the message indicates approval the user begins pumping fuel. The user continues pumping until the fueling is completed. The user may be given the option to indicate that fueling is completing using the mobile app or the PCM may detect the completion of fueling by the absence of flow or the movement of a physical pump handle. When fueling is detected as completed the PCM sends a “fueling completed” message to system server 240. The system server then completes the payment cycle and sends “receipt information” back to the PCM. The PCM then sends the receipt information to the smart phone app and the smart phone app displays this information to the user. Optionally the system server may “push” the receipt information directly to the smart phone app using a cellular connection.

Different embodiments of the invention may incorporate the following features:

1. The ability to use different communication media. In the preferred embodiment of the disclosed invention the communication media was describe as using cellular or mobile networks. Any of the components could also use Wi-Fi, Bluetooth or a wired connection;

2. The ability to act in parallel with existing fuel accounting and or payment systems. In the preferred embodiment of the disclosed invention the disclosed invention was described as a standalone access and billing system. The smart phone acted as the user interface for the initiation of the authorization process of the disclosed invention. The smart phone could also act as the user interface for the authorization process for existing fuel accounting and billing systems;

3. The app software could be loaded on any portable electronic device including a smart phone, a tablet, and a laptop;

4. The ability to use different payment scenarios. In the preferred embodiment of the disclosed invention the disclosed invention uses the user's bank or fuel card via a banking network as a method of payment and billing. The disclosed invention also provides for payment and billing to be via the invoice and or contract route. As an example, the system might accumulate all charges for a particular fleet for a month and then send an invoice to the fleet owner's payment manager;

5. The ability to protect the PCM's from general Internet access with firewalls. The firewalls will provide additional hacking security. The firewalls can also service multiply PCM's thus reducing the number of unique IP addresses needed to service the PCM's;

6. The fact that credit card information or other secure payment information is not actually stored on the remote system server. The system server will of course be protected by appropriate firewalls. However, even in the event of a successful hack, the hacker will not obtain the enrolled users' payment information. Credit card and other payment information will instead be stored encrypted on each individual smart phone. Optionally the login could at the user's request be stored encrypted by the mobile app as well;

7. The hand-held device could be any number of portable electronic devices including smart phones, tablets, laptops, and wristwatch-type personnel apparel devices;

8. The ability of the mobile app to use built-in smart phone functions such as but not limited to finding locations and providing directions based on the locations. One of the most useful of the geographic options is to provide direction to the nearest service station equipped with the present invention;

9. The ability to track and act upon functional discrepancies encountered during system use. Abnormalities can be tracked and reported. Self-test features will function autonomously or they may be initiated by a user at any time. Preventative maintenance procedures can likewise be initiated automatically or manually; and

10. Instead of entering a password on the mobile app a thumb print verification could be used.

The foregoing description of the preferred embodiments of the disclosed system has been presented to illustrate the principles of the disclosed system and not to limit the disclosed system to the particular embodiments illustrated. It is intended that the scope of the disclosed system be defined by all of the embodiments encompassed within the following claims and their equivalents, rather than by any particular example given.

First Shot—Device Claim from Perspective of Smart Phone

Having described our invention, we claim:

1. A fuel payment system for allowing a user to use a fuel dispenser, said fuel dispenser including,
i. a pump control module configured to monitor an amount of fuel dispensed by said fuel dispenser and control dispensing of fuel by said fuel dispenser,
ii. a graphic containing a readable code,
iii. wherein said pump control module includes a limited-range radio frequency transceiver,
iv. said pump control module configured to only provides communication access to said pump control module in response to a defined sequence transmitted by an external device to said transceiver in said pump control module, comprising:
a. a portable electronic device, including,
i. a processor,
ii. a memory associated with said processor,
iii. a camera, and
iv. a radio frequency transceiver;
b. a software application running on said processor in said portable electronic device;
c. said software application configured to store payment information for said user in said memory associated with said processor;
d. said camera being configured to capture said readable code in said graphic on said dispenser;
e. said software application configured to take said captured image of said readable code and determine therefrom said defined sequence to be used to contact said limited-range radio frequency transceiver in said pump control module; and
f. said software application configured to use said transceiver in said portable electronic device to transmit said defined sequence to said transceiver in said pump control module to establish a communication link with said transceiver in said pump control module, and thereafter transmit said payment information over said communication link to said pump control module.

2. A fuel payment system as recited in claim 1, further comprising:
a. a remote system server;
b. a communication link between said pump control module and said remote system server; and
c. wherein said pump control module is configured to transmit said payment information from said portable electronic device to said remote system server over said communication link between said pump control module and said remote system server.

3. A fuel payment system as recited in claim 2, wherein said remote system server is configured to process said payment information and send an authorization to said pump control module over said communication link between said pump control module and said remote system server.

4. A fuel payment system as recited in claim 2, wherein said pump control module is configured to transmit said payment information without permanently storing said payment information.

5. A fuel payment system as recited in claim 3, wherein said remote system server is configured to process said payment information without permanently storing said payment information.

6. A fuel payment system as recited in claim 2, wherein said portable electronic device must be registered with said remote system server before said software application running on said processor in said portable electronic device is permitted to communicate with said pump control module.

7. A fuel payment system as recited in claim 2, wherein said pump control module is configured to record an amount of fuel transferred and transmit said amount to said remote system server over said communication link between said pump control module and said remote system server.

8. A fuel payment system as recited in claim 7, wherein said remote system server is configured to transmit payment information to said communication link between said pump control module and said remote system server.

9. A fuel payment system as recited in claim 8, wherein said pump control module is configured to transmit said payment information to said portable electronic device using said limited-range radio frequency transceiver in said pump control module.

10. A fuel payment system as recited in claim 6, wherein said pump control module is configured to record an amount of fuel transferred and transmit said amount to said remote system server over said communication link between said pump control module and said remote system server.

11. A fuel payment system for allowing a user to use a fuel dispenser, said fuel dispenser including,
i. a pump control module configured to monitor an amount of fuel dispensed by said fuel dispenser and control dispensing of fuel by said fuel dispenser,
ii. a graphic containing a readable code,
iii. wherein said pump control module is configured to communicate via a limited-range radio frequency transceiver associated therewith,
iv. said pump control module configured to only provides communication access to said pump control module in response to a defined sequence transmitted by an external device to said transceiver associated with said pump control module, comprising:
a. a portable electronic device, including,
i. a processor,
ii. a memory associated with said processor,
iii. a camera, and
iv. a radio frequency transceiver;
b. a software application running on said processor in said portable electronic device;
c. said software application configured to store payment information for said user in said memory associated with said processor;
d. said camera being configured to capture an image of said graphic on said dispenser;
e. said software application configured to read said captured image of said readable code and derive therefrom said defined sequence to be used to contact said limited-range radio frequency transceiver associated with said pump control module; and
f. said software application configured to use said transceiver in said portable electronic device to transmit said defined sequence to said transceiver associated with said pump control module to establish a communication link with said transceiver associated with said pump control module, and thereafter transmit said payment information over said communication link to said pump control module.

12. A fuel payment system as recited in claim 11, further comprising:
a. a remote system server;
b. a communication link between said pump control module and said remote system server; and
c. wherein said pump control module is configured to transmit said payment information from said portable electronic device to said remote system server over said communication link between said pump control module and said remote system server.

13. A fuel payment system as recited in claim 12, wherein said remote system server is configured to process said payment information and send an authorization to said pump control module over said communication link between said pump control module and said remote system server.

14. A fuel payment system as recited in claim 12, wherein said pump control module is configured to transmit said payment information without permanently storing said payment information.

15. A fuel payment system as recited in claim 13, wherein said remote system server is configured to process said payment information without permanently storing said payment information.

16. A fuel payment system as recited in claim 12, wherein said portable electronic device must be registered with said remote system server before said software application running on said processor in said portable electronic device is permitted to communicate with said pump control module.

17. A fuel payment system as recited in claim 12, wherein said pump control module is configured to record an amount of fuel transferred and transmit said amount to said remote system server over said communication link between said pump control module and said remote system server.

18. A fuel payment system as recited in claim 17, wherein said remote system server is configured to transmit payment information to said communication link between said pump control module and said remote system server.

19. A fuel payment system as recited in claim 18, wherein said pump control module is configured to transmit said payment information to said portable electronic device using said limited-range radio frequency transceiver in said pump control module.

20. A fuel payment system as recited in claim 16, wherein said pump control module is configured to record an amount of fuel transferred and transmit said amount to said remote system server over said communication link between said pump control module and said remote system server.
